(19) United States
(12) Patent Application Publication
(10) Pub. No.: US 2014/0263424 A1
(43) Pub. Date: Sep. 18, 2014

(54) BEVERAGE CAP TO BE FASTENED ON A BOTTLE AND BOTTLE HAVING A BEVERAGE CAP

(71) Applicant: DIEGO VALENTINO FORTUNA, SOVIZZO (IT)

(72) Inventor: DIEGO VALENTINO FORTUNA, SOVIZZO (IT)

(21) Appl. No.: 14/294,290

(22) Filed: Jun. 3, 2014

Related U.S. Application Data
(63) Continuation of application No. PCT/EP2012/004465, filed on Oct. 25, 2012.

(30) Foreign Application Priority Data
Dec. 3, 2011 (EP) 11009567.6

(51) Int. Cl. B67D 3/00

(52) U.S. Cl. CPC B67D 3/0058
USPC 222/23

(57) ABSTRACT

A beverage cap to be fastened on a bottle includes a volume counter for measuring the actual liquid volume having flowed out of the bottle, a time counter for adjusting a nominal liquid volume during a time interval, and a signaling device for outputting a signal as a function of the actual liquid volume in relation to the nominal liquid volume. A beverage bottle having a beverage cap is also provided.

### CROSS-REFERENCE TO RELATED APPLICATION

This is a continuation, under 35 U.S.C. §120, of copending International Application No. PCT/EP2012/004465, filed Oct. 25, 2012, which designated the United States; this application also claims the priority, under 35 U.S.C. §119, of European Patent Application EP 11 009 567.6, filed Dec. 3, 2011; the prior applications are herewith incorporated by reference in their entirety.

### BACKGROUND OF THE INVENTION

1. Field of the Invention

The invention relates to a beverage cap to be fastened on a bottle. The invention also relates to a bottle having a beverage cap.

The human body contains a large quantity of water. According to the standard values of the World Health Organization (WHO), the share of water of a person of normal weight amounts to approximately 50% to 55% for women and 60% to 65% for men. A healthy body egests daily approximately 2.5 liters of water in the form of urine, sweat, breath and stool. Under physical load, through illness or sports activities, the water quantity egested will increase.

The water quantity egested should be ingested again as soon as possible because the cells in the body are dependent on a sufficient quantity of water. If the body dehydrates, the activity of the cells will considerably be reduced, so that the body is, for example, no longer able to correctly dispose of waste substances. A lasting lack of liquid intake cannot be sufficiently compensated by the body at a later time, with the consequence that damage to health may occur.

Part of the water quantity egested is fed to the body again through food, for example fruits or vegetables. It is, however, necessary to sufficiently drink every day for a suitable supply of liquids. The recommended standard value of liquid intake for an adult individual is approximately 1.5 liters of water per day and, under physical load, it is correspondingly more. In modern everyday life, often the problem arises that many persons do not manage to drink sufficient quantities of liquids. That is sometimes due to the fact that, for example, caffeine-containing or alcoholic beverages additionally extract water from the body, which correspondingly increases the necessary liquid intake.

From the point of view of evolution, the human body is adapted to withstand, to a certain extent, periods of insufficient ingestion of food and liquid. One consequence thereof is the fact that the human body can withstand shorter periods of that kind without an immediate sensation of thirst. That leads, among others, to the fact that due to the manifold activities during the day, one forgets to drink liquids sufficiently and regularly. It is, in particular, desirable to regularly drink small liquid quantities, enabling the body to take in the liquid better and more efficiently than by drinking a large liquid quantity at a time.

German Patent DE 10 2006 039 101 B3 discloses a closure for a bottle which induces a person to drink regularly. The known closure includes a functional area including an alarm. When a user drinks a liquid quantity from the bottle, he/she can reclose it, with the alarm being adjustable in such a way that it will remind the user after some time of drinking anew.

U.S. Patent Application Publication No. 2009/0114675 A1 discloses a dispenser apparatus including an electromagnetic valve and a flow wheel for measuring the amount of liquid passed through the dispenser apparatus. The valve is closed when the amount reaches a predetermined threshold.

U.S. Pat. No. 6,427,871 discloses a liquid dispensing device that is calibrated to pour the same amount of liquid each time it is used. The dispensing device further includes a display and a keypad to provide information to a user.

U.S. Patent Application Publication No. 2008/0114489 A1 discloses a spout e.g. for use at bars or taverns. The spout is part of a system for monitoring the amount of liquid poured from liquid containers. The amount of fluid passed through the spout is estimated by using the time the liquid container is kept at a certain angle.

Through the use of the beverage cap of the above-mentioned type, the alarm just induces the user to drink regularly. That, however, does not guarantee that the user will drink a sufficiently large quantity of liquid.

### SUMMARY OF THE INVENTION

It is accordingly an object of the invention to provide a beverage cap to be fastened on a bottle and a bottle having a beverage cap, which overcome the hereinafore-mentioned disadvantages of the heretofore-known caps and bottles of this general type and which induce a user in a reliable and simple manner to ingest liquid regularly and sufficiently.

With the foregoing and other objects in view there is provided, in accordance with the invention, a beverage cap to be fastened on a bottle, the beverage cap comprising a volume counter for measuring the actual liquid volume having flowed out of a bottle, a time counter for adjusting a nominal liquid volume during a time interval, as well as a signaling device for outputting a signal as a function of the actual liquid volume in relation to the nominal liquid volume. The nominal liquid volume is calculated by a microprocessor, at least partially, as a function of age, sex, height, weight, state of health, and/or a current activity of a user. The daily requirement of liquid depends on a number of factors, and by taking into account as many of these factors as possible, it is possible to determine a suitable value for the nominal liquid volume. In addition, this increases the flexibility of the beverage cap.

Contrary to the state of the art, the actual liquid volume is also captured, in addition to the time interval, and is evaluated with a stored value for a nominal liquid volume. In this way, it is possible to induce the user to drink both regularly and a sufficient quantity of liquid. The term “liquid” is understood in the following, in particular, to be drinking water or mineral water and the term “bottle” is understood, in particular, to be a beverage bottle.

In an expedient embodiment, the beverage cap is provided with a closing area, which is complementarily adapted to a bottle opening of a beverage bottle, so that in closed condition of the beverage bottle, the closing area is coupled with the bottle opening with a form-locking or positive and/or force-locking or non-positive connection. The closing area can be formed, for example, as an internal thread to be screwed onto a corresponding external thread at the bottleneck. An embodiment of the type of a clamping or snap-on closure for closing beverage bottles without an external thread is, for example, also imaginable. In each case, the beverage cap according to the invention forms a reclosable unit with the beverage bottle.

In a preferred embodiment, the actual liquid volume or a measured quantity proportional thereto is captured, for example, by using a volume counter of the type of a flow-rate sensor unit, and a corresponding measuring signal for an evaluation unit is generated. In an expedient embodiment of the invention, the evaluation unit is formed at least substantially of a microcontroller, in which a control program automatically capturing and evaluating the actual and nominal liquid volumes is implemented. Alternatively, the evaluation unit can also be formed, for example, of an application-specific integrated circuit (ASIC).

In a likewise expedient embodiment, the time counter is provided as an internal clock of the microcontroller with a date and hour function. The time interval for the nominal liquid volume can be regulated or adjusted with the clock.

In another advantageous embodiment, the original liquid quantity inside the beverage bottle is stored or can be stored in the control program of the evaluation unit. This makes it possible, for example, to output another signal to the signaling device, as soon as the liquid quantity inside the bottle is running low. The evaluation of the actual liquid volume makes it advantageously possible to remind the user in time of refilling or exchanging the beverage bottle, thus guaranteeing a constantly regular and sufficient intake of liquid. In this way, the beverage cap can easily also be used with smaller beverage bottles during the time interval, which advantageously increases its flexibility.

The beverage cap can be mounted by a user onto the beverage bottle from which he/she wants to regularly drink liquid. When a liquid quantity is drunk from the beverage bottle, the flow-rate sensor unit will capture the flowed-out actual liquid volume. The control program of the evaluation unit compares the captured value of the actual liquid volume with a stored threshold value of the nominal liquid volume as a function of the time interval. When the actual liquid volume reaches the threshold value of the nominal liquid volume, the evaluation unit will send the signal to the signaling device. The signaling device signals to the user that he/she has drunk a sufficient quantity of liquid during the time interval. In a usual development, an alert signal will be sent to the signaling device when the actual liquid volume does not reach, or exceeds, the threshold value of the nominal liquid volume during the time interval. This reminds the user in an advantageous and simple manner of regular drinking.

In a suitable development, the nominal liquid volume is constantly or stepwise increased by using the time counter during the time interval, which lies in particular between 10 and 24 hours. In other words, the time interval is divided into several equitemporal or else non-equitemporal time stretches or periods, in each of which an additional value is added to the nominal liquid volume. This stepwise increase of the nominal liquid volume guarantees that the user regularly drinks a sufficient quantity of liquid. In the following, the term “equitemporal stretches” is particularly understood to be stretches that include the same span of time.

For this purpose, for example, the control program of the evaluation unit is adapted for dividing the time interval into a number of equitemporal time stretches. In each of these time stretches, the threshold value for the nominal liquid volume is successively increased and the value of the actual liquid volume is continuously compared with it. Suitably, the nominal liquid volume is increased by the same amount in each of the successive time stretches. In this way the nominal liquid volume is sequentially increased to the value of the liquid volume inside the beverage bottle.

Instead of using a time interval lying between 10 and 24 hours, the time interval is set or is settable to a value that lies between 1 and 8 hours. This time interval is especially suitable for users that are doing sports, as for example users that participate in a bicycle race. Particularly, the adjustment of the nominal liquid volume is altered accordingly to the time interval.

In an expedient embodiment, the nominal liquid volume is chosen in such a way that it is larger than 0 liters and smaller than 7 liters, in particular smaller than 3 liters. Too much liquid is as unfavorable to the human body as too little liquid. An excessive intake of water may lead, for example, to hyperhydration (“water intoxication”). The limitation of the nominal liquid volume advantageously reduces the risk that the user drinks an excessive amount of liquid.

A preferred development provides a sensor unit for detecting the environmental temperature, the altitude, the humidity of the air of the environment, and/or the heartbeat of the user, as a function of the sensor data of which, at least partially, the nominal liquid volume is stored in a storage and/or calculated by a microprocessor. This dynamic adaption of the nominal liquid volume to the environment and/or the situation of the user guarantees that the beverage cap always calculates a particularly suitable value for the nominal liquid volume.

Sweating of the body and a loss of liquid depend on the environmental temperature and the humidity of the air. Through the provision of a temperature sensor and/or a humidity sensor, the evaluation unit of the beverage cap is suited and adapted for updating the threshold value for the nominal liquid volume by using the data measured by the sensors.

Physical exercise, such as, for example, sports, also increases the loss of liquid of the body. Connection to a pulse-frequency measuring device, in particular in the form of a chest strap, makes it possible to measure the user's pulse and to update the nominal liquid volume by using the measured data. The chest strap can be coupled for that purpose, through a wire, in an electrically conductive manner, with the beverage cap, or else, in a preferred embodiment, by signaling technology and wirelessly, by using wifi and/or Blue Tooth.

In an advantageous embodiment, the beverage cap includes a conduit pipe through which the liquid volume is passed. For example, the flow-rate sensor unit for capturing the actual liquid volume is disposed in the area of the conduit pipe. The conduit pipe serves in mounted condition of the beverage cap as a spout for the beverage bottle.

In an expedient development, the invention includes a valve closing the conduit pipe and a control unit for operating the valve as a function of the actual liquid volume and of the nominal liquid volume. The control unit is controlled by the evaluation unit. The evaluation unit sends, for example, a control signal causing the opening of the valve to the control unit, as long as the captured value for the actual liquid volume is lower than the stored threshold value of the nominal liquid volume. When the captured value for the actual liquid volume reaches or exceeds the stored threshold value of the nominal liquid volume, the evaluation unit will send, for example, a control signal causing the closing of the valve to the control unit. In this way, it is possible in a simple and reliable manner to dispense only the calculated nominal liquid volume, which advantageously further reduces the risk of an excessive intake of liquid by the user.

In a suitable development, a bridging-over or over-riding unit for manually operating the valve is provided. As far as the user, after drinking the nominal liquid volume, is still thirsty, the bridging-over unit will enable him/her to drink more liquid from the beverage bottle. Suitably, the additionally withdrawn liquid volume is also captured as actual liquid volume, and the nominal liquid volume is then newly calculated as a function of the additionally withdrawn liquid volume.

In a likewise expedient development, the conduit pipe includes a flexible mouthpiece. The mouthpiece is constructed, for example, as a nipple-like suction device to be slipped onto the conduit pipe. This facilitates feeding liquid food for babies. In this form of application, the beverage bottle is, in particular, a baby bottle.

In an advantageous embodiment, the beverage cap includes a filter for cleaning the liquid. The filter is, for example, exchangeable and enables filtering out impurities while the liquid is flowing out of the beverage bottle through the beverage cap. This improves the quality of the liquid. This improvement includes, in particular, the removal or reduction of particles such as turbid substances or microorganisms or undesired substances dissolved in the liquid.

In a suitable embodiment, the signaling device is constructed as a loudspeaker, a lamp, a vibration device and/or a display. With the signaling device, the beverage cap is suited and adapted for inducing the user in an audible, visual and/or tactile manner to drink. For example, by using the signaling device, information on the actual liquid volume can be represented. In particular, the actual liquid volume is shown by the display, or the signaling device includes a set of lamps or light-emitting diodes (LEDs), with a fraction of them lighted corresponding to the actual liquid volume and the relation of the actual liquid volume to the nominal liquid volume, respectively. It is also imaginable to show on the display the hour or a countdown counting down the time of the time interval and the nominal liquid volume as well.

In a suitable embodiment of the invention, the beverage cap includes an input device for configuring the time counter. For example, the time interval can be set to a value lying between 1 and 8 hours. Particularly, the input device can be used to change the time interval from a value lying between 10 and 24 hours to a value lying between 1 and 8 hours. In this way, the beverage cap can be used by the user during a normal workday as well as during sporting events, whereby a suitable consumption of the liquid by the user is nevertheless ensured in each case.

The input device is advantageously constructed as one or more operating knobs for manual operation on the beverage cap. Additionally or alternatively, the beverage cap includes a signal antenna through the use of which the beverage cap can be configured through an external device. The external device is, for example, a computer or a smart phone, with the signal antenna being constructed for sending and receiving wifi and/or Blue Tooth signals.

In an advantageous embodiment, the invention includes an adaptor for fixing it on a water tap. With the filter and the adaptor, the beverage cap can thus be used in the household as a water filter. In regions with high water hardness, it is, for example, possible, by using the beverage cap on a water tap, to reduce the water hardness in such a way that less calcium deposits develop in devices for hot-water processing and other vessels.

With the objects of the invention in view, there is concomitantly provided a beverage bottle, in particular a bicycle bottle, which is coupled with the beverage cap and can be closed by the latter. Preferably, the beverage bottle has a volume between 0.5 liters and 7 liters, in particular, between 0.75 liters and 2 liters. Generally, however, a corresponding beverage cap can also be used for closing another liquid container.

Other features which are considered as characteristic for the invention are set forth in the appended claims.

Although the invention is illustrated and described herein as embodied in a beverage cap to be fastened on a bottle and a bottle having a beverage cap, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a first embodiment of a beverage cap according to the invention;

FIG. 2 is a vertical-sectional view of the beverage cap taken along a line II-II of FIG. 1, in the direction of the arrows;

FIG. 3 is a perspective view of a second embodiment of the beverage cap;

FIG. 4 is a perspective view of a third embodiment of the beverage cap;

FIG. 5 is a perspective view of a fourth embodiment of the beverage cap;

FIG. 6 is a side-elevational view of the beverage cap of FIG. 4, mounted on a beverage bottle; and

FIG. 7 is a perspective view of the beverage cap of FIG. 5 with an adaptor hose in a condition mounted with a water tap.

### DETAILED DESCRIPTION OF THE INVENTION

Referring now in detail to the figures of the drawings, in which parts and sizes corresponding to each other are indicated with the same reference numbers, and first, particularly, to FIGS. 1 and 2 thereof, there is seen a beverage cap 2 according to the invention, including a closing area 4 for closing a beverage bottle, a housing 6 and a spout 8, which may have a flexible mouth piece, for pouring out or drinking a liquid. The closing area 4 includes an internal thread which can be screwed onto a non-illustrated external thread on a bottleneck of a beverage bottle 10, as is seen in FIG. 6. The closing area 4 and the spout 8 are substantially hollow-cylindrical metallic line pipes with a round cross-section, which are coupled with each other inside the housing 6 from the point of view of flow technology. The housing 6 in this embodiment has a substantially rectangular shape and is made of a metallic or plastic-type material. The housing 6 includes a loudspeaker 12 on its surface for emitting an audio signal for a user.

The closing area 4 is disposed approximately centrically on the lower side, i.e. on that side of the housing 6 which in mounted conditions faces towards the beverage bottle 10. The spout 8 is disposed approximately centrically on one of the side faces of the housing 6, approximately at right angles to the closing area 4. In this embodiment, the closing area 4 and the spout 8 form an approximately L-shaped line system through which a liquid will flow when the beverage cap 2 is used.

The loudspeaker 12 is disposed in an upper corner area of the front side of the housing 6. In addition to the loudspeaker 12, the surface of the housing 6 includes three push-button-like operating knobs 18 as input devices, as well as a digital display 20 for displaying information. In the drawing, only one of the operating knobs 18 is marked with a reference number, by way of example. The display 20 is substantially a strip-like LCD screen or an LED display, disposed approximately centrically on the upper side of the housing 6. The three operating knobs 18 are disposed, equally spaced, at the lower end of the front side of the housing 6.

As is evident from FIG. 2, the housing 6 includes a microcontroller 14 as an evaluation unit, which is disposed inside the housing 6. The microcontroller 14 includes an internal clock 16 as a time counter. The closing area 4 includes an exchangeable activated-carbon filter 22 inside the housing 6 for improving the quality of the liquid during use of the beverage cap 2.

The closing area 4 and the spout 8 are undetachably coupled with each other inside the housing 6, substantially at right angles, by a weld seam 24. It is, however, also imaginable that the closing area 4 and the spout 8 could be partial areas of a single line pipe, which is bent, for example, in the corresponding L-shape.

A flow-rate sensor 26 is disposed in the area of the weld seam 24 as a volume counter, which captures the actual liquid volume flowing out through the spout 8 and generates a corresponding measuring signal Vᵢₛₜ for the microcontroller 14 as a measure of the flowed-out liquid volume.

Through the use of the operating knobs 18, a user can manually configure a time interval At for adjusting a nominal liquid volume Vₛₒᵢₗ by generating an operating signal B for the microcontroller 14. Therefore information on the user, that is her/his age, sex, height, weight, state of health and/or current activity, can be programmed into the microcontroller 14 by using the operating knobs 18 and the operating signal B. The microcontroller 14 is adapted for determining a value for the nominal liquid volume Vₛₒᵢₗ at least partially as a function of this additional information.

In the area of the weld seam 24, a valve 28 is disposed inside the spout 8, which can be opened or closed as a function of a control signal S from a control unit 30 coupled from the point of view of signal technology with the valve 28. In a closed state of the valve 28, substantially no liquid can flow out of the spout 8.

For the intended use, the user screws the beverage cap 2 onto a beverage bottle 10 from which he/she wishes to regularly drink liquid. The time interval At as well as additional information are input into the microcontroller 14 by manual operation of the operating knobs 18. The time interval At can, however, also be fixedly stored in the microcontroller 14 or can be directly calculated as a function of an input made by using the operating knobs 18. Based on these data, the microcontroller 14 calculates a threshold value for the nominal liquid volume Vₛₒᵢₗ. The microcontroller 14 divides the time interval At into a number of time stretches, with the threshold value for the nominal liquid volume Vₛₒᵢₗ being successively increased stepwise in each time stretch.

In an alternative or additional embodiment, the microcontroller is adapted for storing the developments in time of the actual liquid volume Vᵢₛₜ as well as of the nominal liquid volume Vₛₒᵢₗ in a storage device. The microcontroller 14 evaluates the developments in time and is adapted for calculating the nominal liquid volume Vₛₒᵢₗ in subsequent applications of the beverage cap 2 at least partially as a function of the evaluated developments. It is imaginable or conceivable, for example, to adapt the number and duration of the stretches or periods of time or to increase the nominal liquid volume Vₛₒᵢₗ step-wise. This enables an at least partial adaption to the user and his/her drinking behavior.

During use, the microcontroller 14 substantially continuously compares the value of the actual liquid volume Vᵢₛₜ captured by the flow-rate sensor 26, with the stored threshold value of the nominal liquid volume Vₛₒᵢₗ in a time stretch or period of the time interval Δt. As long as the value of the actual liquid volume Vᵢₛₜ is lower than the value of the nominal liquid volume Vₛₒᵢₗ, the valve 28 will be open, so that liquid can flow out through the spout 8. If the actual liquid volume Vᵢₛₜ reaches or exceeds the threshold value of the nominal liquid volume Vₛₒᵢₗ within the time stretch, a control signal S_{zu} closing the valve 28 will be sent from the microcontroller 14 to the control unit 30. If the threshold value is not reached within the time stretch, the microcontroller 14 will send an alert signal W to the loudspeaker 12 for emitting an audio signal to induce the user to drink.

If time counting of the clock 16 reaches the end of a time stretch of the time interval At, the microcontroller 14 will increase the threshold value of the nominal liquid volume Vₛₒᵢₗ at the beginning of the next time stretch and will send a signal S_{auf} to the control unit 30 opening the valve 28. The microcontroller 14 also sends an alert signal W′ to the loudspeaker 12 for emission of another audio signal informing the user that the valve 28 is open again. Preferably, the audio signal of the loudspeaker 12 caused by the alert signal W and the one caused by the alert signal W′ can easily be distinguished acoustically by the user.

During operation of one of the operating knobs 18, it is, furthermore, provided that a bridging-over signal U is sent to the microcontroller 14. Upon receipt of the bridging-over or over-ride signal U, the microcontroller sends the control signal S_{auf} to the control unit 30 for opening the valve 28. This enables the user to open the valve 28 manually, so that he/she can drink more liquid, if desired.

The indications on the display 20 can be controlled through a display signal D of the microcontroller 14. Through the use of the operating signal B, it is, for example, possible to permute between several different indications on the display 20. It is, for example, imaginable to display the time interval Δt, the actual liquid volume Vᵢₛₜ and/or the nominal liquid volume Vₛₒᵢₗ. Additionally or alternatively, it is, however, likewise imaginable that the display 20 indicates a visual alert signal W″, for example a flashlight, similar to the audio signals of the loudspeaker 12.

FIG. 3 shows a first alternative embodiment of the beverage cap 2. Contrary to the above-described embodiment, the housing 6 only includes the loudspeaker 12. The operating knobs 18 and the display 20 have been omitted. The information for the user is exclusively effected through the loudspeaker 12 by using the acoustic alert signals W, W′. Furthermore, this beverage cap 2 has no valve 28. Rather, the water can be dispensed at any time, with the actual liquid volume Vᵢₛₜ withdrawn still being captured, however, by using the flow-rate sensor 26. The time interval Δt is firmly stored in the microcontroller 14, because the latter cannot be influenced.

FIG. 4 is a representation of a second alternative embodiment of the beverage cap 2. In this embodiment, contrary to the embodiment shown in FIG. 1 and FIG. 2, the beverage cap 2 additionally includes an antenna 32 for sending and receiving wireless signals, as well as a connector 34 for external devices. The antenna 32 is, in particular, adapted for sending and receiving wifi and Blue-Tooth signals. The antenna 32 and the connector 34 are coupled with the microcontroller 14 from the point of view of signal technology.

The microcontroller 14 generates the signals to be sent by the antenna 32 and evaluates the signals received. In this way, it is possible, for example, to program the operating signal B for configuring the time interval At and the nominal liquid volume Vₛₒᵢₗ into the beverage cap 2 by using a computer or a smart phone or, for example, to call data about the consumption of liquid to a computer or a smart phone. It is likewise imaginable to receive wireless signals of a chest strap for capturing the user's pulse frequency. The microcontroller can use such measured data, at least partially, for determining the optimum nominal liquid volume Vₛₒᵢₗ. Furthermore, for example, new functions, new software or software updates, for example from the Internet, can be downloaded and installed on the beverage cap 2 through the signals received.

The connector 34 serves for coupling, from the point of view of signal technology, the beverage cap 2, in particular the microcontroller 14, with an external device. In this embodiment, the external device is, in particular, a non-illustrated USB storage medium and the connector 34 is a female USB plug. In this way, it is possible, for example, to transfer the developments in time of the actual liquid volume Vᵢₛₜ as well as of the nominal liquid volume Vₛₒᵢₗ or other data from the storage of the microcontroller 14 to the USB storage medium and thus to evaluate on a computer, for example, the daily, weekly and/or monthly development.

In the following, a fourth embodiment variant of the beverage cap 2 with a cylindrical housing 6′ will be explained through the use of FIG. 5, which is rotated through 180° with respect to its normal operating orientation to show certain features. In this embodiment, shown in FIG. 5, the closing area 4 is disposed approximately centrically in the lower surface of the housing 6′, with the spout 8 being disposed on the opposite surface, also substantially centrically. The lower surface also includes the loudspeaker 12 and a light-emitting diode (LED) 36 for sending a visual signal to the user. Three operating knobs 18 are disposed in the upper part of the lateral area of the housing 6′. The display 20 is disposed in the lower part. The connector 34 and a battery compartment 38 are disposed at the side of the display 20. Button batteries for the current supply of the beverage cap 2, for example, can be placed in the battery compartment 38.

The LED 36 is coupled, from the point of view of signal technology, with the microcontroller 14 and generates a visual signal to induce the user to drink. For example, the LED 36 may light up when the valve 28 is open. It is also imaginable for the LED 36 to light up in different colors, depending on the opening state of the valve 28, for example in red for closed and green for open.

A non-illustrated temperature sensor 40, a non-illustrated altitude sensor 42, as well as a non-illustrated humidity sensor 44 are disposed on the upper surface. The temperature sensor 40, the altitude sensor 42 as well as the humidity sensor 44 are coupled, from the point of view of signal technology, with the micro-controller 14. The microcontroller 14 is adapted for continuously evaluating the captured measuring signals of the temperature sensor 40, of the altitude sensor 42 and of the humidity sensor 44 and thus to adapt the threshold value for the nominal liquid volume Vₛₒᵢₗ dynamically to the ambient temperature, the difference in altitude, and the humidity of the air.

FIG. 6 shows the beverage cap 2 according to the third embodiment variant, mounted on the beverage bottle 10. The beverage bottle 10 is, in particular, a bicycle bottle made of plastic with a filling volume of about 0.75 liters. In this configuration the time interval Δt is set to a value of 2 hours.

In the following, the application of the beverage cap 2 according to the fourth embodiment variant, when connected to a water tap 46 by using an adaptor hose 48, will be explained through the use of FIG. 7. The adaptor hose 48 is made of an elastic rubber material and includes at each of its ends a respective connection area 50A and 50B. The beverage-cap-side connection area 50A has a beverage-bottle-like external thread, onto which the beverage cap 2 can easily be screwed in a watertight manner. The water-tap-side connection area 50B is suited and adapted for being fastened on the water tap 46 with form-locking or positive and/or force-locking or non-positive connections. In this way, the water tap 46 is coupled, from the point of view of flow technology, with the spout 8, so that, for example, the water from the water tap 46 can be filtered by the activated-carbon filter 22. The user is induced by using the loudspeaker 12 or the LED 36 to drink, and/or the valve 28 is operated as a function of the actual liquid volume Vᵢₛₜ in relation to the nominal liquid volume Vₛₒᵢₗ.

In a suitable dimensioning, the housing 6 or the housing 6′ is approximately 3.5 cm long, 3.5 cm wide and 1.5 cm high. The closing area 4 has a diameter of approximately 2.5 cm and a height of 1 cm, so that it can easily be screwed onto conventional bottle threads. The spout 8 has a diameter of about 1.0 cm and a height of 1.5 cm. In an expedient embodiment, the adaptor hose 48 is approximately 20 cm to 30 cm long.

The invention is not limited to the above-described exemplary embodiments. Rather, a person skilled in the art can derive other variants of the invention therefrom, without deviating from the subject matter of the invention. In particular, furthermore, all individual features described in connection with the various exemplary embodiments can also be combined with each other in another manner, without deviating from the subject matter of the invention.

1. A beverage cap to be fastened on a bottle, the beverage cap comprising:
a volume counter configured to measure an actual liquid volume having flowed out of the bottle;
a microprocessor configured to calculate a nominal liquid volume at least partially as a function of at least one of age, sex, height, weight, state of health or current activity of a user;
a time counter configured to adjust said nominal liquid volume using a time interval; and
a signal device configured to output a signal as a function of said actual liquid volume in relation to said nominal liquid volume.

2. The beverage cap according to claim 1, wherein said time counter is configured to increase said nominal liquid volume constantly or stepwise over said time interval.

3. The beverage cap according to claim 2, wherein said time interval lies between 10 and 24 hours.

4. The beverage cap according to claim 2, wherein said time interval can be set to a value lying between 1 and 8 hours.

5. The beverage cap according to claim 1, wherein said nominal liquid volume is larger than 0 liters and smaller than 7 liters.

6. The beverage cap according to claim 1, wherein said nominal liquid volume is larger than 0 liters and smaller than 3 liters.

7. The beverage cap according to claim 1, which further comprises:
a sensor unit configured to detect at least one of an environmental temperature, an altitude, a humidity of air of the environment or the heartbeat of a user and to output sensor data;
said nominal liquid volume being at least one of stored or calculated by said microprocessor at least partially as a function of said sensor data of said sensor unit.

8. The beverage cap according to claim 1, which further comprises a conduit pipe through which the liquid volume is passed.

9. The beverage cap according to claim 8, which further comprises:
a valve configured to close said conduit pipe; and
a control unit configured to operate said valve as a function of said actual liquid volume and said nominal liquid volume.

10. The beverage cap according to claim 9, which further comprises a bridging-over unit configured to manually operate said valve.

11. The beverage cap according to claim 8, wherein said conduit pipe includes a flexible mouth piece.

12. The beverage cap according to claim 1, which further comprises a filter configured to clean the liquid.

13. The beverage cap according to claim 1, wherein said signal device is at least one device selected from the group consisting of a loudspeaker, a lamp, a vibration device or a display configured to indicate said actual liquid volume.

14. The beverage cap according to claim 1, which further comprises an input device for configuring said time counter.

15. The beverage cap according to claim 14, wherein said input device sets said time interval to a value lying between 1 and 8 hours.

16. The beverage cap according to claim 1, which further comprises an adaptor configured to fix the beverage cap on a water tap.

17. A beverage bottle, comprising a beverage cap according to claim 1.

18. The beverage bottle according to claim 17, wherein the beverage bottle is a bicycle bottle.

19. The beverage bottle according to claim 17, wherein the beverage bottle has a volume between 0.5 liters and 7 liters.

20. The beverage bottle according to claim 17, wherein the beverage bottle has a volume between 0.75 liters and 2 liters.
